(19) United States
(12) Patent Application Publication
(10) Pub. No.: US 2004/0080390 A1
(43) Pub. Date: Apr. 29, 2004

(54) Ignition coil and techniques for introducing encapsulating material therein

(76) Inventors: Viorel N. Moga, Anderson, IN (US); Albert Anthony Skinner, Anderson, IN (US); Larrie A. Davis, McCordsville, IN (US); Arlen P. Suter, Pendleton, IN (US)

Correspondence Address: MARGARET A. DOBROWITSKY, DELPHI TECHNOLOGIES, INC., Legal Staff, Mail Code: 480-410-202, P.O. Box 5052, Troy, MI, 48007-5052, US

(21) Appl. No.: 10/278,565

(22) Filed: Oct. 23, 2002

(51) Int. Cl. H01F 27/02

(52) U.S. Cl. 336/96

(57) ABSTRACT

Method for introducing encapsulating material into an ignition coil including a primary winding, a secondary winding and a secondary spool is provided. The method allows providing a fluid-directing device at a first end of the secondary spool. The method further allows providing flow communication between the fluid-directing device and a first channel defined between the outer diameter of the primary winding and the inner diameter of the secondary spool. Flow communication is provided between the first channel and a second channel at a distal end from the first end. The second channel defined between the outer diameter of the secondary winding and the housing of the ignition coil. Encapsulating material (either pressurized or non-pressurized) is introduced through the fluid-directing device for generally downwardly flow into the first channel. At the distal end, the downwardly flow is turned into a generally upwardly flow into the second channel to avoid the trapping of air as the encapsulating material fills the second channel. Another aspect of the invention provides an ignition coil constructed to implement the foregoing encapsulating techniques.

### BACKGROUND OF THE INVENTION

Ignition coils (or pencil coils) for internal combustion engines may be configured to be directly coupled to spark plugs. Such ignition coils use both a primary coil and a secondary coil. The primary coil typically operates at a low voltage, while higher voltages are induced in the secondary coil.

In one common ignition coil design, it is known to use an appropriate thermosetting material, e.g., epoxy, for encapsulating purposes. That is, to fill with the appropriate encapsulating material the channels or passageways defined by the primary and secondary coils. A problem may arise due to the relatively small clearance available for epoxy flow relative to the primary and secondary coils. For example, in a coil design having the secondary coil co-axially positioned relative to the primary coil, and a plastic case acting as a dielectric barrier between the secondary and the magnetic return path, the clearance for epoxy flow may be typically no more than approximately 0.3 to 0.5 mm. If one were to provide more room for epoxy flow, this would undesirably reduce the available volume of the coil for accommodating its operational components, such as the core, windings, and the shield.

Present techniques allow for simultaneously introducing the epoxy along the two channels defined by the primary and secondary coils. Even though the coils are generally encapsulated under vacuum, some residual air in the coil could get trapped and lead to voids (e.g., air bubbles) in the final product. These voids are particularly undesirable along the outer diameter (OD) of the secondary coil or in the secondary windings themselves. Positioning the coils at an angle with respect to the direction of flow of the epoxy to incrementally enhance the flow down one channel relative to the other channel may somewhat reduce the possibility of trapping air. However, this tilting technique does not consistently ensure that air will not be trapped and further this technique adds complexity and cost to the encapsulating equipment.

In view of the foregoing considerations, it would be desirable to provide ignition coil and techniques that at a low cost consistently enable the epoxy to flow in a manner that avoids or substantially reduces the trapping of air bubbles as the epoxy flows about the primary and secondary coils. More particularly, it would be desirable to flow the epoxy down one of such channels first, and then continue to fill the other channel essentially from the bottom to avoid the trapping of air. It would be also desirable to optionally provide means for pressurizing the encapsulating material being introduced for filling the channels of the ignition coil so as to reduce the cycle time of the encapsulation operation, if so opted.

### BRIEF SUMMARY OF THE INVENTION

Generally, the present invention fulfills the foregoing needs by providing in one aspect thereof, a method for introducing encapsulating material into an ignition coil comprising a primary winding, a secondary winding co-axially disposed relative to the primary winding, and a secondary spool for receiving the secondary winding. The method allows providing a fluid-directing device at a first end of the secondary spool. The method further allows providing flow communication between the fluid-directing device and a first channel defined between the outer diameter of the primary winding and the inner diameter of the secondary spool. Flow communication is provided between the first channel and a second channel at a distal end from the first end. The second channel is defined between the outer diameter of the secondary winding and the housing of the ignition coil. Encapsulating material may be introduced through the fluid-directing device for generally downwardly flow into the first channel. At the distal end, the downwardly flow is turned into a generally upwardly flow into the second channel to avoid the trapping of air as the encapsulating material fills the second channel.

In another aspect thereof, the present invention further fulfills the foregoing needs by providing an ignition coil comprising a primary winding, a secondary winding co-axially disposed relative to the primary winding, and a secondary spool for receiving the secondary winding. A fluid-directing device may be provided at a first end of the secondary spool. A first channel is defined between the outer diameter of the primary winding and the inner diameter of the secondary spool. The first channel is flowingly connected to the fluid-directing device. A second channel is flowingly connected with the first channel at a distal end from the first end. The second channel is defined between the outer diameter of the secondary winding and the housing of the ignition coil, wherein encapsulating material is introduced for downwardly flow through the fluid-directing device into the first channel. Flow-turning structure may be configured to turn the downwardly flow of encapsulating material passing from the first channel to an upwardly flow into the second channel so as to avoid the trapping of air as the encapsulating material fills the second channel.

In yet another aspect of the invention, a method for introducing encapsulating material into an ignition coil allows providing a device for directing pressurized fluid at a first end of the secondary spool. The method further provides flow communication between the fluid-directing device and a first channel defined between the outer diameter of the primary winding and the inner diameter of the secondary spool. Flow communication is provided between the first channel and a second channel at a distal end from the first end, the second channel defined between the outer diameter of the secondary winding and the housing of the ignition coil. Pressurized encapsulating material is introduced through the fluid-directing device into the first channel; and at the distal end, the flow of encapsulating material passing from the first channel is turned into a generally upwardly flow into the second channel to avoid the trapping of air as the encapsulating material fills the second channel.

In still another aspect of the invention, an ignition coil including a primary winding, a secondary winding co-axially disposed relative to the primary winding, and a secondary spool for receiving the secondary winding is provided. The coil further includes a device for directing pressurized fluid at a first end of the secondary spool. A first channel is defined between the outer diameter of the primary winding and the inner diameter of the secondary spool. The first channel is flowingly connected to the fluid-directing device. A second channel is flowingly connected with the first channel at a distal end from the first end. The second channel is defined between the outer diameter of the secondary winding and the housing of the ignition coil, wherein pressurized encapsulating material is introduced through the fluid-directing device into the first channel. Flow-turning structure is configured to turn the flow of encapsulating material passing from the first channel to an upwardly flow into the second channel so as to avoid the trapping of air as the encapsulating material fills the second channel.

### BRIEF DESCRIPTION OF THE DRAWINGS

The features and advantages of the present invention will become apparent from the following detailed description of the invention when read with the accompanying drawings in which:

FIG. 1 is a cross-section of an exemplary ignition coil embodying aspects of the present invention for introducing, for example, through a fluid-directing device encapsulating material for filling respective coil channels while avoiding the formation of air bubbles therein.

FIG. 2 is top view of the fluid-directing device of FIG. 1 including an interface circuit mounted through a window in the fluid-directing device.

FIG. 3 illustrates an exemplary configuration of the window for receiving the interface circuit of FIG. 2.

FIG. 4 is, in part, a cross-section of an exemplary ignition coil embodying aspects of the present invention for introducing pressurized encapsulating material for filling the respective coil channels while avoiding the formation of air bubbles therein.

### DETAILED DESCRIPTION OF THE INVENTION

The inventors of the present invention have innovatively recognized structure and techniques that are believed to improve the quality of ignition or pencil coils. More particularly, during the encapsulating operation, in lieu of simultaneously introducing encapsulant downwardly along each of the two channels defined by the primary and secondary coils of the ignition coil, flowing the epoxy down one of such channels first, and then continuing to fill the other channel, essentially from the bottom up, allows venting any residual air and this avoids the trapping of air and any resulting voids, or air bubbles. Elimination of residual air is particularly desirable in the vicinity or in the secondary coil. In one aspect of the invention, the flow of encapsulating material may be gravity-induced. In another aspect of the invention, structure for directing appropriately pressurized encapsulating material may also be provided so that in this other embodiment the flow of encapsulating material is pressure-induced.

In one exemplary embodiment, a secondary spool may be configured to include a fluid-directing device that would define a large opening at a top end of the spool, e.g., the low voltage side of the coil, relative to the channel (or passageway) between the inner diameter (ID) of the secondary spool and the outer diameter (OD) of the primary winding. For example, with the top of the secondary spool configured as a fluid-directing device, encapsulant may initially flow downwardly just between the inner diameter (ID) of the secondary spool and the outer diameter (OD) of the primary winding. If some residual air is trapped in this first channel relative to the primary coil, this is not expected to affect the quality of the ignition coil. In this exemplary embodiment, the encapsulant would eventually flow out at the bottom of the core through one or more core pin openings and would then be upwardly directed to fill the second channel. For example, the channel defined between the OD of the secondary and the ID of the housing. As suggested above, since the filling of the second channel is essentially from the bottom up, this allows for venting any residual air therein and thus avoids the trapping of air and any concomitant voids, or air bubbles relative to the secondary coil.

FIG. 1 generally illustrates an ignition coil assembly 1 in accordance with aspects of the present invention. Exemplary structure for performing the actions discussed in the preceding paragraphs will be specifically discussed below. However, prior to such specific discussion a general discussion of the coil assembly 1 is deemed appropriate.

Referring to FIG. 1, ignition coil assembly 1 has a substantially rigid outer housing 2 at one end of which there may be appended a spark plug assembly (not shown). For readers desirous of further general background information regarding ignition coils reference is made to U.S. patent applications Ser. Nos. 6,276,348 and 6,232,863, each assigned in common to the same assignee of the present invention and herein incorporated by reference. At the other end of the ignition coil there may be a control circuit interface portion 4 (e.g., printed circuit board (PCB)) for external electrical interface with the engine control unit (or electronic control module), not shown. Assembly 1 further includes a high voltage transformer including substantially coaxially arranged primary 10 and secondary 12 coil windings and a high permeability cylindrically shaped magnetic core 9.

A transformer portion is formed around a central magnetic core 9. For example, the magnetic core 9 may be manufactured from plastic coated iron particles in a compression molding operation. After the core 9 is molded, it is appropriately machined, such as by grinding, to provide a generally smooth surface free, for example, from sharp mold parting lines, which otherwise could be detrimental to the efficient operation primary coil winding 10 thereon. Core 9 may also be formed of laminating structure, such as made up of thin silicon-steel plates of differing widths so that a cross-section thereof becomes substantially circular. Magnets having an appropriate polarity may be disposed respectively on both ends of iron core 9.

Primary coil 10 is wound directly on the cylindrical outer surface of core 9. The primary windings are typically formed from insulated wire, which are wound directly upon the outer cylindrical surface of the core 9. In some exemplary embodiments, the primary coil 10 may comprise two winding layers each in turn being comprised of from about 120 to 140 turns of No. 23 (or Nos. 21-25) AWG wire. In certain embodiments, voltages of from about 350 to 450 volts may be present in the primary coil 10, and the wire of that coil may have a diameter of from about 0.5 to 0.7 mm. Insulated copper wire may be utilized. The winding of the primary coil 10 being directly upon core 9 allows for efficient heat transfer of the primary resistive losses and improved magnetic coupling.

The primary sub-assembly may be inserted into the annulus spacing defined by cylindrical secondary spool 11. The secondary coil 12 is wound onto the outer surface of the secondary spool 11. The progressive windings of coil 12 may have from about 15,000 to 25,000 turns or wraps around the mid-section of secondary spool 11 to induce voltages higher than in the primary coil. The wire of the secondary coil may have a diameter of from about 0.05 to 0.07 mm in certain embodiments. Voltages of from about 8,000 to 40,000 volts may be induced in the secondary coil 12. By way of example, secondary spool 11 may be formed of an injection molded plastic insulating material having high temperature tolerance, such as a polybutylene terephthalate (PBT) thermoplastic polyester, LCP, or PPS.

As shown in FIG. 1, in accordance with aspects of the present invention, a fluid-directing device 20, such as a funnel, may be provided at a first end of the secondary spool. It will be appreciated that as used herein, the fluid-directing device is not limited to funnel-like devices since the fluid-directing device may be configured in shapes other than conical shapes. In one exemplary embodiment, the fluid-directing device may be integrally constructed (e.g., by molding) with the secondary spool. In general, however, the fluid-directing device need not be integrally constructed with the secondary spool. A first channel 22 is defined between the outer diameter of the primary winding and the inner diameter of the secondary spool. The first channel is flowingly connected to the fluid-directing device so as to allow passage to encapsulating material, for example. A second channel 24 is flowingly connected with the first channel at a distal end 26 from the first end. The second channel is defined between the outer diameter of the secondary winding and the housing of the ignition coil. In one exemplary embodiment, encapsulating material (represented by a plurality of downwardly pointing arrows) is introduced for downwardly flow through the fluid-directing device into the first channel. Flow-turning structure 28 is configured to turn the downwardly flow of encapsulating material passing from the first channel to an upwardly flow (represented by a plurality of upwardly pointing arrows) into the second channel so as to avoid the trapping of air as the encapsulating material fills the second channel. In one exemplary embodiment, the flow-turning structure defines openings at the very bottom of the spool, which are usually provided to keep the core of the mold in place during high pressure injection molding. That is, for purposes other than encapsulating. These opening are usually referred to as core pin holes. The use of these so called core pin holes is advantageous in one exemplary embodiment since it allows usage of structure already part of the ignition coil, and consequently avoids time consuming and expensive retooling, retrofitting, retesting costs, etc.

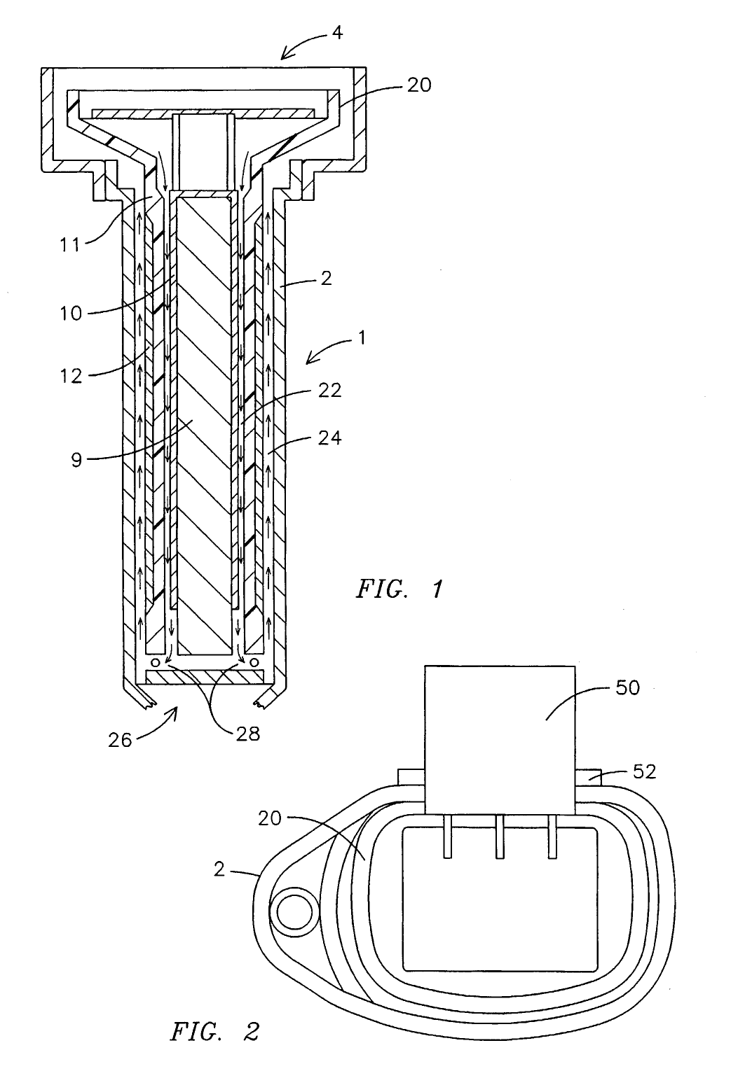

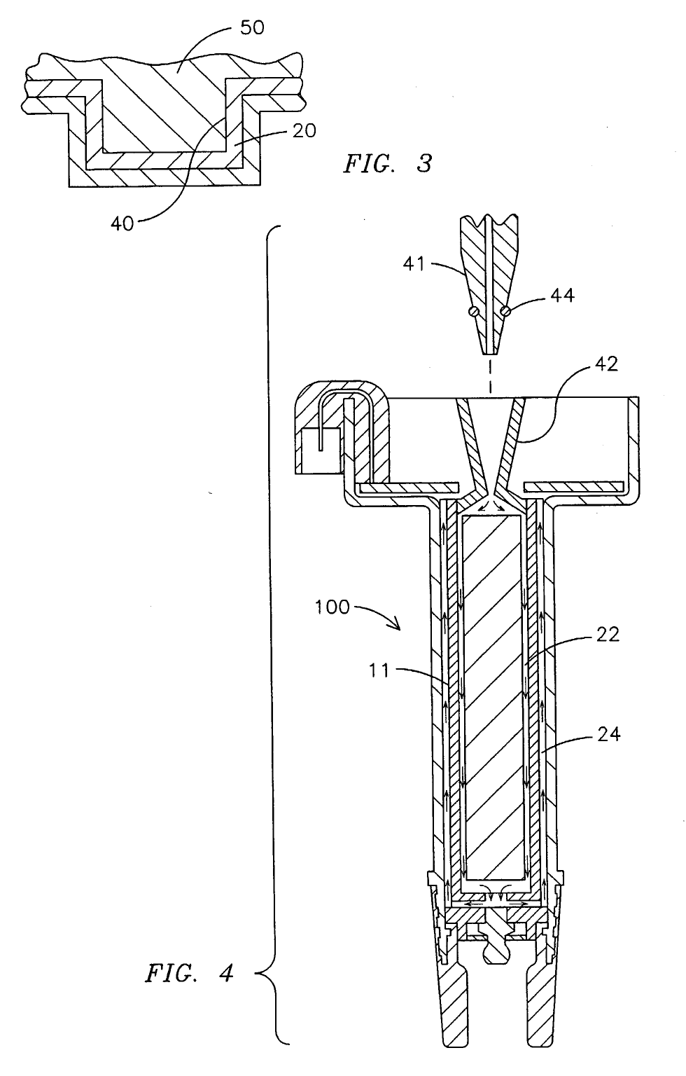

As shown in FIG. 3, a window 40 may be provided in the walls of the fluid-directing device for receiving a standard interface circuit 50 (FIG. 2), such as a connector. The housing of the connector may include a flange 52 configured to provide a sealed press fit to the connector relative to the window. That is, the fit between the interface circuit and the window should be sealed so that no encapsulating materials flows from the fluid-directing device through the window,

FIG. 4 is, in part, a cross-section of an exemplary ignition coil 100 embodying other aspects of the present invention for introducing pressurized encapsulating material for filling the respective coil channels while avoiding the formation of air bubbles therein. As shown in FIG. 4, a device 42 for directing pressurized fluid may be provided at a first end of the secondary spool 11. In one exemplary embodiment, standard pressurizing equipment (not shown) for dispensing pressurized encapsulating material may include a dispensing nozzle 41. By way of example, the nozzle may be tapered to correspond with the corresponding engaging surfaces in device 42. A sealing ring 44 may be provided to provide sealing engagement between nozzle 40 and fluid-directing device 42. Although the sealing ring is shown installed on nozzle 40, it will be appreciated that sealing ring could be part of device 42. As suggested above, this aspect of the invention is not limited to conically-shaped configurations since other configurations, such as cylindrical, may prove to be useful for delivering the pressurized encapsulant. In operation, the pressurized encapsulating material is introduced through the fluid-directing device into the first channel, and, as suggested above, flow-turning structure is configured to turn the flow of encapsulating material passing from the first channel to an upwardly flow into the second channel so as to avoid the trapping of air as the encapsulating material fills the second channel. This embodiment may be useful to reduce the cycle time for delivering the encapsulating material into the coil channels. Further, the flow of encapsulating material is not dependent on gravity, and therefore the alignment of the ignition coil relative to gravity is inconsequential. It is also believed that pressurizing the encapsulant is conducive to a more consistent impregnation of the encapsulant relative to the coils, particularly in areas that may not be readily accessibly to non-pressurized flow. In one exemplary practical implementation, the funnel wall may be dimensioned to match the top wall of the housing. Moreover, dispensing (e.g., overfilling) issues of the encapsulant may be avoided by dimensioning the funnel wall above the cast height of the encapsulant.

While the preferred embodiments of the present invention have been shown and described herein, it will be obvious that such embodiments are provided by way of example only. Numerous variations, changes and substitutions will occur to those of skill in the art without departing from the invention herein. Accordingly, it is intended that the invention be limited only by the spirit and scope of the appended claims.

What is claimed is:

1. A method for introducing encapsulating material into an ignition coil comprising a primary winding, a secondary winding co-axially disposed relative to the primary winding, and a secondary spool for receiving the secondary winding, the method comprising:
providing a fluid-directing device at a first end of the secondary spool;
providing flow communication between the fluid-directing device and a first channel defined between the outer diameter of the primary winding and the inner diameter of the secondary spool;
providing flow communication between the first channel and a second channel at a distal end from the first end, the second channel defined between the outer diameter of the secondary winding and the housing of the ignition coil;
introducing encapsulating material through the fluid-directing device for generally downwardly flow into the first channel; and
at the distal end, turning the downwardly flow into a generally upwardly flow into the second channel to avoid the trapping of air as the encapsulating material fills the second channel.

2. The method of claim 1 further comprising defining a window in the fluid-directing device for receiving an interface circuit.

3. The method of claim 2 further comprising sealingly mounting the interface circuit through the window.

4. An ignition coil comprising:
a primary winding;
a secondary winding co-axially disposed relative to the primary winding;
a secondary spool for receiving the secondary winding;
a fluid-directing device at a first end of the secondary spool;
a first channel defined between the outer diameter of the primary winding and the inner diameter of the secondary spool, the first channel flowingly connected to the fluid-directing device;
a second channel flowingly connected with the first channel at a distal end from the first end, the second channel defined between the outer diameter of the secondary winding and the housing of the ignition coil, wherein encapsulating material is introduced for downwardly flow through the fluid-directing device into the first channel; and
flow-turning structure configured to turn the downwardly flow of encapsulating material passing from the first channel to an upwardly flow into the second channel so as to avoid the trapping of air as the encapsulating material fills the second channel.

5. The ignition coil of claim 4 further comprising a window in the fluid-directing device for receiving an interface.

6. The ignition coil of claim 5 wherein the window is configured to sealingly receive the interface circuit.

7. The ignition coil of claim 4 wherein the fluid-directing device comprises a funnel.

8. An ignition coil comprising:
a primary winding;
a secondary winding co-axially disposed relative to the primary winding;
a secondary spool for receiving the secondary winding;
a fluid-directing device at a first end of the secondary spool;
a first channel flowingly connected to the fluid-directing device;
a second channel flowingly connected with the first channel at a distal end from the first end; and
flow-turning structure configured to turn downwardly flow of material passing from one of the channels to an upwardly flow into the other channel so as to avoid the trapping of air as the material fills the other channel.

9. The ignition coil of claim 8 wherein the first channel is defined between the outer diameter of the primary winding and the inner diameter of the secondary spool.

10. The ignition coil of claim 9 wherein the second channel is defined between the outer diameter of the secondary winding and the housing of the ignition coil.

11. The ignition coil of claim 10 wherein encapsulating material is introduced for downwardly flow through the fluid-directing device into the first channel.

12. The ignition coil of claim 11 wherein the flow-turning structure turns the downwardly flow of encapsulating material passing from the first channel to an upwardly flow into the second channel.

13. The ignition coil of claim 12 wherein the fluid-directing device comprises a funnel.

14. A method for introducing encapsulating material into an ignition coil comprising a primary winding, a secondary winding co-axially disposed relative to the primary winding, and a secondary spool for receiving the secondary winding, the method comprising:
providing a fluid-directing device at a first end of the secondary spool;
flowingly connecting a first channel to the fluid-directing device;
flowingly connecting a second channel with the first channel at a distal end from the first end; and
turning downwardly flow of material passing from one of the channels to an upwardly flow into the other channel so as to avoid the trapping of air as the material fills the other channel.

15. The method of claim 14 wherein the first channel is defined between the outer diameter of the primary winding and the inner diameter of the secondary spool.

16. The method of claim 15 wherein the second channel is defined between the outer diameter of the secondary winding and the housing of the ignition coil.

17. The method of claim 16 further comprising introducing encapsulating material through the fluid-directing device for downwardly flow into the first channel.

18. The method of claim 17 further comprising turning the downwardly flow of encapsulating material passing from the first channel to an upwardly flow into the second channel.

19. A method for introducing encapsulating material into an ignition coil comprising a primary winding, a secondary winding co-axially disposed relative to the primary winding, and a secondary spool for receiving the secondary winding, the method comprising:
providing a device for directing pressurized fluid at a first end of the secondary spool;
providing flow communication between the fluid-directing device and a first channel defined between the outer diameter of the primary winding and the inner diameter of the secondary spool;
providing flow communication between the first channel and a second channel at a distal end from the first end, the second channel defined between the outer diameter of the secondary winding and the housing of the ignition coil;
introducing pressurized encapsulating material through the fluid-directing device into the first channel; and
at the distal end, turning the flow of encapsulating material passing from the first channel into a generally upwardly flow into the second channel to avoid the trapping of air as the encapsulating material fills the second channel.

20. An ignition coil comprising:
a primary winding;
a secondary winding co-axially disposed relative to the primary winding;
a secondary spool for receiving the secondary winding;
a device for directing pressurized fluid at a first end of the secondary spool;
a first channel defined between the outer diameter of the primary winding and the inner diameter of the secondary spool, the first channel flowingly connected to the fluid-directing device;
a second channel flowingly connected with the first channel at a distal end from the first end, the second channel defined between the outer diameter of the secondary winding and the housing of the ignition coil, wherein pressurized encapsulating material is introduced through the fluid-directing device into the first channel; and
flow-turning structure configured to turn the flow of encapsulating material passing from the first channel to an upwardly flow into the second channel so as to avoid the trapping of air as the encapsulating material fills the second channel.

21. The ignition coil of claim 20 wherein the device directing pressurized fluid comprises a nozzle, and a funnel configured to engagingly receive the nozzle.

22. The ignition coil of claim 21 wherein the nozzle and the funnel are configured to provide a mutually corresponding taper to the surfaces providing engagement therebetween.

23. The ignition coil of claim 21 further comprising a sealing ring for providing a sealing engagement between the nozzle and the funnel.
